(19) United States
(12) Patent Application Publication
(10) Pub. No.: US 2022/0154818 A1
(43) Pub. Date: May 19, 2022

(54) AUTOMATIC TRANSMISSION

(71) Applicants: JATCO Ltd, Fuji-shi, Shizuoka (JP); NISSAN MOTOR CO., LTD., Yokohama-shi, Kanagawa (JP)

(72) Inventors: Jongho PARK, Seoul (KR); Yuhyung NAM, Seoul (KR); Jungil PARK, Seoul (KR); Kenji SAKAKIBARA, Sagamihara-shi, Kanagawa (JP); Hiroyuki TSUBOI, Isehara-shi, Kanagawa (JP); Akiko IMAI, Isehara-shi, Kanagawa (JP); Hiroki SAITO, Fujisawa-shi, Kanagawa (JP)

(73) Assignees: JATCO Ltd, Fuji-shi, Shizuoka (JP); NISSAN MOTOR CO., LTD., Yokohama-shi, Kanagawa (JP)

(21) Appl. No.: 17/442,266

(22) PCT Filed: Nov. 13, 2019
(86) PCT No.: PCT/JP2019/044468

§ 371 Date: Sep. 23, 2021

(30) Foreign Application Priority Data
Mar. 27, 2019 (JP) 2019-059694

(51) Int. Cl. F16H 61/02

(52) U.S. Cl. CPC F16H 61/0276; F16H 2061/0279

(57) ABSTRACT

The control valve assembly is provided with a reinforcing portion straddling a drain port, the drain port allowing communication between an inside and an outside of the control valve assembly. The reinforcing portion is provided along a bore in which a spool of the control valve for control is housed. The control valve for control is a pressure regulator vale regulating a line pressure, the line pressure being a primary pressure of a hydraulic oil of the automatic transmission.

### TECHNICAL FIELD

The present invention relates to an automatic transmission.

### BACKGROUND ART

Patent Literature 1 discloses an automatic transmission provided with a control valve assembly which includes a control valve inside and a drain port communicating with the outside.

However, the control valve assembly of Patent Literature 1 may be greatly deformed by the axial force of the fastening bolts or the high-pressure hydraulic oil due to the poor rigidity in the vicinity of the drain port communicating with the outside.

### CITATION LIST

### Patent Literature

Patent Literature 1: JP2000-74190A

### SUMMARY OF INVENTION

The present invention has been made in view of such a technical problem. An object of the present invention is to provide an automatic transmission provided with a control valve assembly in which a large deformation is suppressed.

The automatic transmission provided with a control valve assembly according to the present invention is characterized in that the control valve assembly is provided with a reinforcing portion straddling a drain port, the drain port allowing communication between an inside and an outside of the control valve assembly.

Therefore, in the automatic transmission provided with the control valve assembly according to the present invention, the rigidity in the vicinity of the drain port communicating with the outside is increased, thereby a large deformation can be suppressed.

### BRIEF DESCRIPTION OF DRAWINGS

FIG. 1 is a schematic view of an automatic transmission provided with a control valve assembly according to a first embodiment as viewed from a side.

FIG. 2 is a perspective view of the control valve assembly according to the first embodiment as viewed from a lower body side.

FIG. 3 is a section A-A of FIG. 2.

### DESCRIPTION OF EMBODIMENTS

### First Embodiment

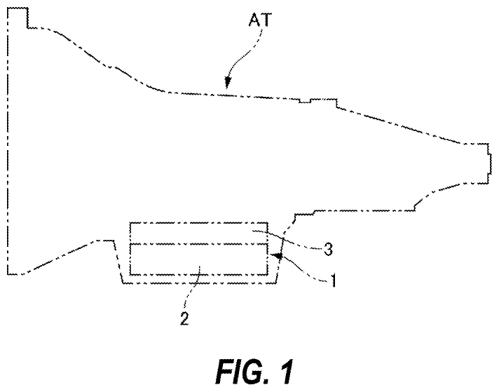

FIG. 1 is a schematic view of an automatic transmission AT provided with a control valve assembly 1 according to a first embodiment as viewed from a side.

The automatic transmission AT has at its lower part a control valve assembly 1. The control valve assembly includes a lower body which includes a control valve inside and a drain port communicating with an outside, and an upper body 3.

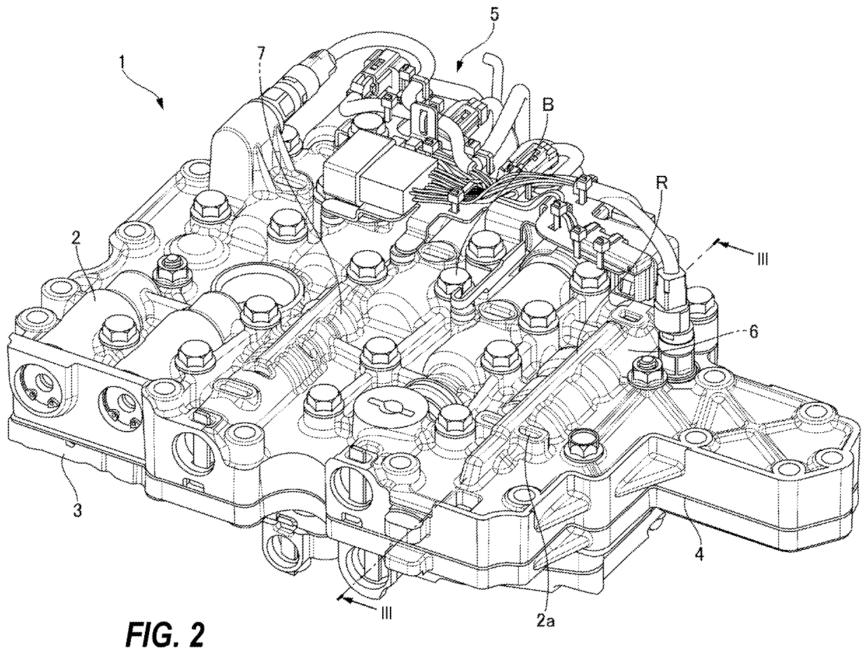

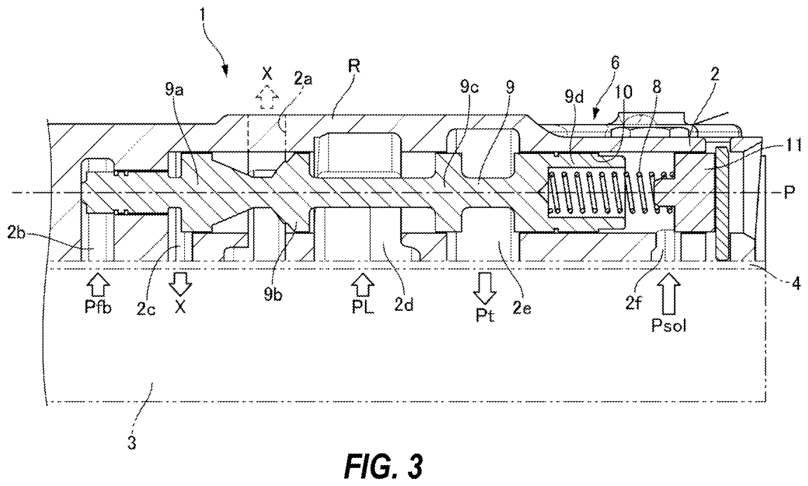

FIG. 2 is a perspective view of the control valve assembly 1 according to the first embodiment as viewed from the lower body side. FIG. 3 is a section A-A of FIG. 2.

The lower body 2 accommodates a pressure regulator valve (control valve for control) 6 that regulates a line pressure PL that is a primary pressure of the hydraulic oil of the automatic transmission AT, and a lockup control valve (control valve for control) 7 that controls an operation of a lockup clutch (not shown) and so on.

Further, a plurality of solenoids 5 generating control pressures for controlling the pressure regulator valve 6, the lockup control valve 7 and so on are arranged on a side surface of the lower body 2.

The lower body 2 of the control valve assembly 1 is integrated with the upper body 3 via a separate plate 4 with a plurality of fastening bolts B.

The lower body 2 accommodating the pressure regulator valve 6 for regulating the pressure of the hydraulic oil of the automatic transmission AT is provided with a drain port 2a for regulating the pressure.

In order to increase a rigidity in a vicinity of the drain port 2a, as shown in FIG. 3, a rib R (reinforcing portion) straddling the drain port 2a is formed, on the outer surface of the lower body 2 and parallel to an axis P of a spool 9 of the pressure regulator valve 6, to have a length substantially the same as an axial length of the spool 9.

The configuration of the pressure regulator valve 6 will be described with reference to FIG. 3.

A bore 10 is formed inside the lower body 2. The spool 9 of the pressure regulator valve 6 is housed in the bore 10.

Inside the bore 10, an adapter 11 is press-fitted at a right side end in the figure.

Further, the spool 9 is slidably housed in the bore 10 while a spring 8 is arranged between the adapter 11 and a land 9d of the spool 9.

The lower body 2 between the adapter 11 and the land 9d of the spool 9 is formed with a port 2f to which hydraulic oil at a line pressure controlling solenoid pressure Psol, which is controlled by the solenoid 5 for line pressure control, is supplied.

A port 2e for supplying hydraulic oil at a torque converter pressure Pt to a torque converter (not shown) is formed in the lower body 2 between the land 9d and a land 9c of the spool 9.

Further, a port 2d, to which the hydraulic oil at an oil pump discharge pressure discharged by an oil pump, not shown, is supplied, is formed in the lower body 2 between the land 9c and a land 9b of the spool 9.

The spool 9 of the pressure regulator valve 6 regulates and generates the line pressure PL by draining the hydraulic oil at the oil pump discharge pressure to the drain port 2a in the lower body 2 formed between the land 9b and a land 9a of the spool 9 or the port 2e, according to a balance of the line pressure control solenoid pressure Psol supplied to the port 2f and a biasing force of the spring 8 to a feedback pressure Pfb (line pressure PL) supplied to a feedback port 2b.

A drain port 2c drains a leaked hydraulic oil.

Further, as shown in FIG. 3, the drain port 2a is blocked by the rib R. However, as for draining, there is no problem with an operation of the pressure regulator valve 6 since the drain port 2a is open in the direction orthogonal to the axis P of the spool 9 as shown in FIG. 2.

As a result, the rigidity in the vicinity where the drain port 2a allowing communication between the inside and the outside of the control valve assembly 1 is formed can be increased, and a large deformation can be suppressed.

The effect will be described hereinafter.

The automatic transmission AT provided with the control valve assembly 1 according to the first embodiment achieves the effect recited below.

(1) On the outer surface of the lower body 2, the rib R straddling the drain port 2a having a length substantially the same as the axial length of the spool 9 is provided in parallel with the axis P of the spool 9 of the pressure regulator valve 6. Therefore, the rigidity in the vicinity where the drain port 2a is formed can be increased, and a large deformation can be suppressed.

Although embodiments for carrying out the present invention have been described based on an embodiment, specific configurations of the present invention are not limited to the configurations shown in the embodiment, and design changes and the like within the scope not departing from the gist of the invention are also included in the present invention.

1. An automatic transmission comprising:
a control valve assembly including a control valve for control, at least an upper body accommodating the control valve for control, and a lower body, wherein
the control valve assembly is provided with a reinforcing portion straddling a drain port, the drain port allowing communication between an inside and an outside of the control valve assembly, and
the reinforcing portion is provided along a bore in which a spool of the control valve for control is housed, and
the control valve for control is a pressure regulator vale regulating a line pressure, the line pressure being a primary pressure of a hydraulic oil of the automatic transmission.

2. The automatic transmission according to claim 1, wherein
the reinforcing portion is formed to have a length substantially the same as an axial length of the spool.
